(19) United States
(12) Patent Application Publication
(10) Pub. No.: US 2010/0218392 A1
(43) Pub. Date: Sep. 2, 2010

(54) LEVEL MEASURING DEVICE

(75) Inventor: Jin-Shi Lai, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: HONG FU JIN PRECISION INDUSTRY (ShenZhen) CO., LTD, Shenzhen City (CN); HON HAI PRECISION INDUSTRY CO., LTD., Tu-Cheng (TW)

(21) Appl. No.: 12/436,096

(22) Filed: May 5, 2009

(30) Foreign Application Priority Data
Mar. 2, 2009 (CN) 200910300644.1

(51) Int. Cl. G01C 9/14; G01C 9/02

(52) U.S. Cl. 33/397; 33/391

(57) ABSTRACT

A level measuring device for measuring the level of a surface includes a support, a first pivot shaft, a second pivot shaft, a pendulum, a first rotation sensor, a second rotation sensor and a computing module. The support includes a bottom surface which is configured for contacting the surface. The first pivot shaft is rotatably supported by the support. The second pivot shaft is rotatably linked to the first pivot shaft and perpendicular to each other. The pendulum is suspended from the second pivot shaft. The first rotation sensor and the second rotation sensor are configured for sensing rotated angle and direction of the first pivot shaft and the second pivot shaft, caused by the displacement of the pendulum. The computing module is configured for calculating the level of the surface using the rotated angle and direction.

### BACKGROUND

1. Technical Field

The present disclosure relates to measuring devices and, particularly, to a level measuring device capable of simultaneously measuring the level of a surface two dimensionally.

2. Description of Related Art

Level measuring devices are used to measure the level of a surface. Currently, the most common level measuring devices are a spirit level. To measure the level of the two dimension of a surface, two measurements must be taken with the spirit level. This is very inconvenient.

What is needed, therefore, is a level measuring device which can overcome the above-described problems.

### BRIEF DESCRIPTION OF THE DRAWINGS

FIG. 1 is an isometric, exploded view of a level measuring device according to the present disclosure.

FIG. 2 is a partially sectioned, schematic view of a level measuring device according to the present disclosure.

### DETAILED DESCRIPTION

Embodiments of the level measuring device will now be described in detail with reference to the drawings.

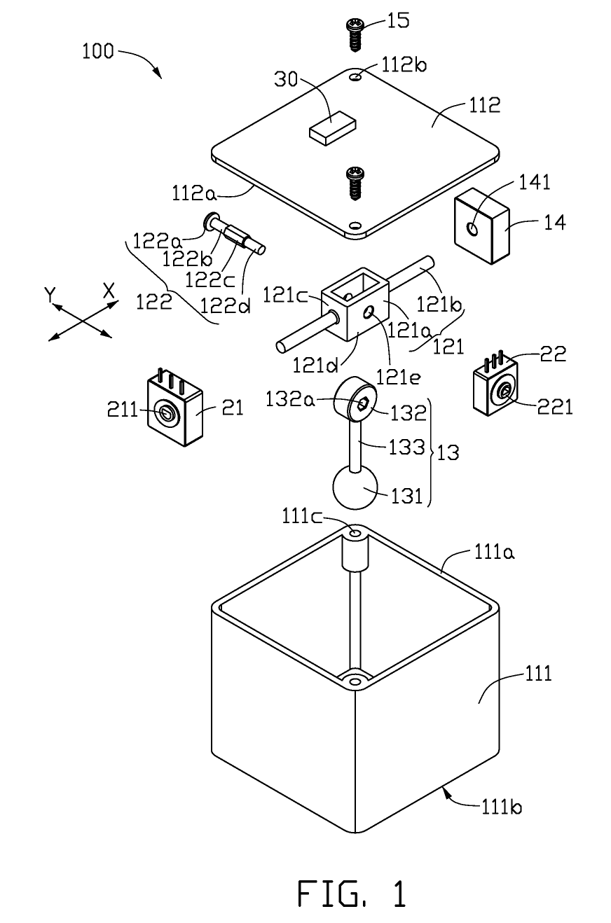

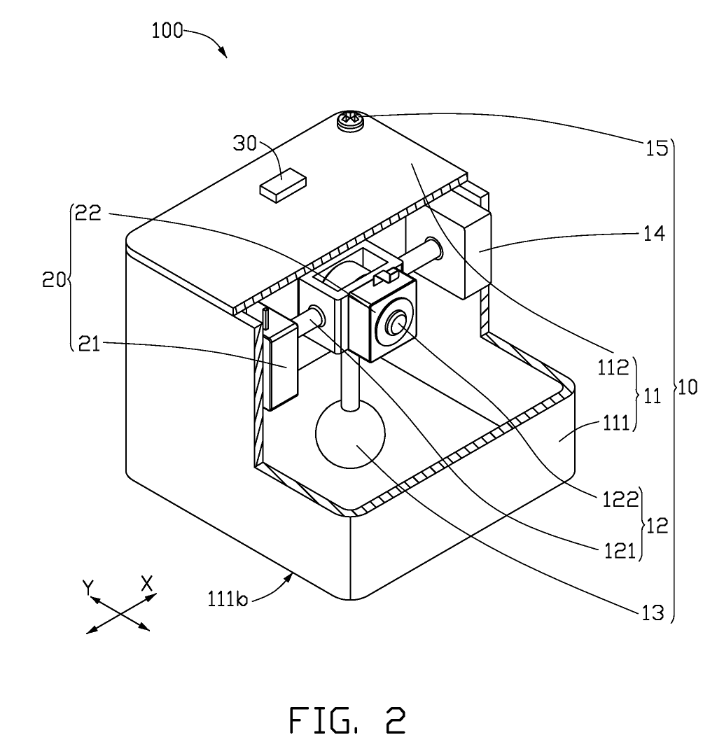

Referring to the FIGS. 1-2, one embodiment of a level measuring device 100 is used to measure the level of a surface (not shown) two dimensionally. The level measuring device 100 includes a two-axis gimbal 10, two rotation sensors 20, and a computing module 30.

The two-axis gimbal 10 includes a support 11, two orthogonal pivot shafts 12, a pendulum 13, a fulcrum seat 14, and two screws 15. The two orthogonal pivot shafts 12 are rotatably supported on the support 11. The pendulum 13 is suspended on the two orthogonal pivot shafts 12.

In this embodiment, the support 11 is box-shaped and the support 11 includes a casing 111 and a cover 112. The casing 111 includes an upper surface 111a and a bottom surface 111b. The upper surface 111a defines two first screw holes 111c therein. The bottom surface 111b is a flat, smooth surface and is configured for contacting the surface, and reflecting the level of the surface to the two-axis gimbal 10. The cover 112 includes an inner surface 112a, and defines two second screw holes 112b corresponding to the first screw holes 111c.

The two orthogonal pivot shafts 12 is configured for transmitting level information of the level of the bottom surface 111b to the two rotation sensors 20 correspondingly. The two orthogonal pivot shafts 12 include a first pivot shaft 121 and a second pivot shaft 122.

The first pivot shaft 121 is configured for measuring the angular and directional displacement of the pendulum 13 around a first direction, such as the X-axis of FIG. 1. The first pivot shaft 121 includes a holding part 121a and two pivot pins 121b. The holding part 121a is a cuboid-shaped frame. The holding part 121a includes a pair of first side walls 121c on opposite sides of the holding part 121a and a pair of second side walls 121d between the first side walls 121c. Two pivot pins 121b extend outwardly from the first side walls 121c correspondingly. The second side walls 121d defines a pair of pivot holes 121e.

The second pivot shaft 122 is configured for measuring the angular and directional displacement of the pendulum 13 around a second direction, that is, the Y-axis of FIG. 1. The second pivot shaft 122 includes, in order from one end to another end, a stopping cap 122a, a first cylinder 122b, a polygonal cylinder 122c, and a second cylinder 122d.

Due to gravity, the pendulum 13 points to the direction of the Earth's center. The pendulum 13 includes a bob 131, a pivot 132 and a rod 133. The rod 133 is used to link the bob 131 and the pivot 132. The bob 131 is a sphere, and is made from high density material. The pivot 132 is cylinder, and defines, along the axial direction of the pivot 132, a through hole 132a. The through hole 132a is polygonal-shaped matching the shape of the polygonal cylinder 122c. The rod 133 is disposed at the side of the pivot 132.

The fulcrum seat 14 is configured for supporting the first pivot shaft 121. The fulcrum seat 14 defines a shaft hole 141.

Two rotation sensors 20 includes a first rotation sensor 21 and a second rotation sensor 22. The first rotation sensor 21 is configured for sensing the rotated angle and direction of the first pivot shaft 121, from a first origin. The first rotation sensor 21 includes a first inner ring 211. The first inner ring 211 rotates about the axis thereof. The second rotation sensor 22 is configured for sensing the rotated angle and direction of the second pivot shaft 122, from a second origin. The second rotation sensor 22 includes a second inner ring 221. The second inner ring 221 rotates around the axis thereof. When the pendulum 13 is at rest, the first and second pivot shafts 121, 122 are at the first and second origins correspondingly. In this embodiment, the two rotation sensors 20 are rotary encoder.

The computing module 30 is configured for computing the level of the surface according to the rotated angle and direction of the first pivot shaft 121 and the second pivot shaft 122. The computing module 30 is disposed on the cover 112.

In assembly, the first rotation sensor 21 and the fulcrum seat 14 are mounted on opposite side of the inner surface 112a of the cover 112 and a connecting axis between the first rotation sensor 21 and the fulcrum seat 14 is parallel to the X axis. The first rotation sensor 21 is electrically connected to the computing module 30. The first pivot shaft 121 is rotatably disposed between the first rotation sensor 21 and the fulcrum seat 14. One of the pivot pins 121b is engaged with the first inner ring 211, and another pivot pin 121b is rotatably received in the shaft hole 141. The second rotation sensor 22 is attached on one of the second side walls 121d, and is electrically connected to the computing module 30. The pivot 132 is received in the holding part 121a. The second pivot shaft 122 is rotatably passed through the pivot holes 121e and the through hole 132a via the second cylinder 122d until the first cylinder 122b is non-rotatably engaged with the through hole 132a. Consequently, the second cylinder 122d is engaged with the second inner ring 221 so that the second pivot shaft 122 is parallel to the Y axis. The cover 112 is located on the upper surface 111a. The screws 15 are screwed through the second screw holes 112b and the first screw holes 111c to fasten the cover 112 with the casing 111.

In use, the level measuring device 100 is placed on a to-be-measured surface. If the surface is inclined, the pendulum 13 deviates from the equilibrium position and drives the two orthogonal pivot shafts 12 to rotate from their origin. The rotated angle and direction can be sensed by the rotation sensors 20 and the level of the surface is measured.

When the pendulum 13 deviates from the X axis, the pivot 132 drives the second pivot shaft 122 to rotate from the second origin. The second rotation sensor 22 senses the rotation angle and direction of the second pivot shaft 122. The second rotation sensor 22 transforms the measurement of the rotation angle and direction into a digital signal, and transmits the digital signal to the computing module 30.

When the pendulum 13 deviates from the Y axis, the pivot 132 drives the first pivot shaft 121 to rotate from the first origin. The first rotation sensor 21 senses the rotation angle and direction of the first pivot shaft 121. The first rotation sensor 21 transforms the measurement of the rotation angle and direction into a digital signal, and transmits the digital signal to the computing module 30.

The computing module 30 computes the digital signals transmitted from the first rotation sensor 21 and the second rotation sensor 22, and computes the level of the to-be-measured surface two dimensionally.

In this embodiment, a display screen is disposed on the level measuring device 100 to display the level of the to-be-measured surface.

It will be understood that the above particular embodiments and methods are shown and described by way of illustration only. The principles and the features of the present invention may be employed in various and numerous embodiment thereof without departing from the scope of the invention as claimed. The above-described embodiments illustrate the scope of the invention but do not restrict the scope of the invention.

What is claimed is:

1. A level measuring device for measuring a level of a surface, comprising:
a support comprising a bottom surface configured for contacting the to-be-measured surface;
a first pivot shaft rotatably supported by the support;
a second pivot shaft rotatably linked to the first pivot shaft and perpendicular to each other;
a pendulum suspended from the second pivot shaft;
a first rotation sensor configured for sensing the rotated angle and direction of the first pivot shaft, caused by the displacement of the pendulum;
a second rotation sensor configured for sensing the rotated angle and direction of the second pivot shaft, caused by the displacement of the pendulum; and
a computing module configured for calculating the level of the surface according to the rotated angle and direction of the first and second pivot shafts.

2. The level measuring device as claimed in claim 1, wherein the support is box-shaped and comprises a casing and a cover.

3. The level measuring device as claimed in claim 2, further comprising a fulcrum seat, wherein the fulcrum seat and the first rotation sensor are mounted on opposite sides of the cover.

4. The level measuring device as claimed in claim 3, wherein the first pivot shaft comprises a holding part and two pivot pins, one of the pivot pins being engaged with the first rotation sensor and another pivot pin being rotatably received in the fulcrum seat.

5. The level measuring device as claimed in claim 4, wherein the holding part comprises a pair of first side walls and a pair of second side walls, and the pair of first side walls are disposed between the pair of second side walls; the second side walls define a pair of pivot holes.

6. The level measuring device as claimed in claim 5, wherein the pendulum comprises a bob, a pivot and a rod, the rod used to link the bob and the pivot; the pivot defines, along the axial direction of the pivot, a through hole.

7. The level measuring device as claimed in claim 6, wherein the second pivot shaft is rotatably inserted through the pivot holes and is non-rotatably engaged with the through hole

8. The level measuring device as claimed in claim 2, wherein the computing module is disposed on the cover.

9. The level measuring device as claimed in claim 8, wherein the first and second rotation sensors are electrically connected with the computing module.

10. A level measuring device configured for measuring a level of a surface, comprising:
a two-axis gimbal comprising a bottom surface, two orthogonal pivot shafts and a pendulum, the bottom surface being configured for contacting the surface, the pendulum suspended from the two orthogonal pivot shafts;
two rotation sensors each configured for sensing a rotated angle and direction of a corresponding pivot shaft, and
a computing module configured for calculating the level of the surface according to the rotated angles and directions of the first and second pivot shaft.
